(19) United States
(12) Patent Application Publication
(10) Pub. No.: US 2006/0093825 A1
(43) Pub. Date: May 4, 2006

(54) Reflection sheet, display device having the same, and method

(76) Inventors: Sang-Hoon Lee, Yongin-si (KR); Ju-Hwa Ha, Seoul (KR); Si-Joon Song, Yongin-si (KR)

Correspondence Address: CANTOR COLBURN, LLP, 55 GRIFFIN ROAD SOUTH, BLOOMFIELD, CT, 06002, US

(21) Appl. No.: 11/261,278

(22) Filed: Oct. 28, 2005

(30) Foreign Application Priority Data
Oct. 28, 2004 (KR) 2004-86720

(51) Int. Cl. B32B 9/04

(52) U.S. Cl. 428/411.1

(57) ABSTRACT

A reflection sheet includes a reflection layer that reflects light irradiated from an external device and a dissipating layer that is formed on the reflection layer and dissipates the heat generated from a lamp unit in a horizontal direction toward an outside of the lamp unit. The dissipation layer has a thermal conductivity in a horizontal direction higher than that in a vertical direction and thus the heat may rapidly be transmitted to a first container. As a result, this may suppress the increment of temperatures in a backlight assembly, increase the luminance of the lamp unit, and improve a display quality of a liquid crystal display device.

This application claims priority to Korean Patent Application No. 2004-86720, filed on Oct. 28, 2004 and all the benefits accruing therefrom under 35 USC § 119, and the contents of which in its entirety are herein incorporated by reference.

### BACKGROUND OF THE INVENTION

1. Field of the Invention

The present invention relates to a reflection sheet, a display device having the reflection sheet, and a method. More particularly, the present invention relates to a reflection sheet having the improvement of display quality a display device having the reflection sheet, and a method of using the reflection sheet to improve display quality.

2. Description of the Related Art

In general, a display device displays images corresponding to image signals that are inputted into the display device from an external device. A liquid crystal display (“LCD”) device, as one type of such display devices, displays images using optical characteristics of liquid crystal.

The LCD device includes an LCD panel for displaying images using light and a backlight assembly for providing the light to the LCD panel. The backlight assembly may be classified into an edge illumination type and a direct illumination type according to positions of lamps.

The direct illumination type backlight assembly includes a plurality of lamps that provide light to an LCD panel, a reflection sheet that reflects the light toward the LCD panel, and a container that receives the reflection sheet. Meanwhile, a heat is generated from the lamps when operating the backlight assembly.

FIG. 1 is a plan view illustrating a conventional direct illumination type backlight assembly.

Referring to FIG. 1, a lamp unit 10 includes a plurality of lamp tubes 11 that emit light responding to amounts of electric currents provided thereto, a cold electrode 12 that is mounted at a first end of each of the lamp tubes 11 and provides the electric currents to each of the lamp tubes 11, and a hot electrode 13 that is installed at a second end of each of the lamp tubes 11 opposite to the first end of each of the lamp tubes 13 and provides the electric currents to each of the lamp tubes 11. The lamp tubes 11 are spaced apart from each other in a first direction and extend in a second direction substantially perpendicular to the first direction. The hot electrode 13 has a voltage higher than that of the cold electrode 12.

To inspect a temperature distribution over the lamp unit 10 in accordance with positions of the lamp tubes 11 and differences between voltages of the lamp tubes 11, the lamp unit 10 is divided into first, second, third, fourth, fifth, sixth, seventh, eighth, and ninth regions A1, A2, A3, A4, A5, A6, A7, A8, and A9 having substantially the same sizes.

Meanwhile, the LCD device is used in an upright position with respect to its flat surface. The first, second, and third regions A1, A2, and A3 are positioned on a first plane in a horizontal direction with respect to and adjacent to the flat surface of the LCD device. The fourth, fifth, and sixth regions A4, A5, and A6 are positioned on a second plane, which is higher than the first plane from the flat surface of the LCD device, in the horizontal direction and substantially in parallel with the first, second, and third regions A1, A2, and A3. The seventh, eighth, and ninth regions A7, A8, and A9 are positioned on a third plane, which is higher than the second plane from the flat surface of the LCD device, in the horizontal direction and substantially in parallel with the fourth, fifth, and sixth regions A4, A5, and A6

Temperatures of each of the first, . . . , ninth regions A1, . . . , A9 are measured when the lamp unit 10 operates. The measured temperatures of the first, . . . , ninth regions A1, . . . , A9 are shown in Table 1 as follows.

TABLE 1

| | Regions | | | | | | | | |
|---|---|---|---|---|---|---|---|---|---|
| | A1 | A2 | A3 | A4 | A5 | A6 | A7 | A8 | A9 |
| Temperature (° C.) | 43.36 | 46.60 | 53.83 | 45.24 | 46.81 | 53.71 | 51.76 | 54.37 | 56.92 |

As shown in Table 1, the seventh, eighth, and ninth regions A7, A8, and A9 positioned at an upper portion of the LCD panel have temperatures higher than those of the rest of the regions because the heat generated from the LCD panel concentrates on the upper portion of the LCD panel by a convention effect. When a temperature of a region surrounding the lamp unit 10 is no less than about 45° C., a vapor pressure of a mercury gas in the lamp unit 10 may vary so that a luminance of the lamp unit 10 is decreased. As a result, the upper portion of the LCD panel may have a luminance lower than that of other portions of the LCD panel, thereby reducing a display quality of the LCD device.

Since a large amount of heat is generated from the hot electrode 13 to which a relatively high voltage is applied, the third, sixth, and ninth regions A3, A6, and A9 have temperatures higher than those of other regions. This causes a drift of the mercury gas in the lamp unit 10 toward its one side so that one portion of the LCD panel adjacent to the hot electrode 13 has a luminance different from that of the other portion of the LCD panel adjacent to the cold electrode 12.

That is, the temperatures of the first, . . . , ninth regions become higher proportional to an increase in a distance from the flat surface of the LCD panel and a decrease in a distance from the hot electrode 13. In particular, the ninth region A9 positioned at the upper portion of the LCD panel and adjacent to the hot electrode 13 has the highest temperature of about 56.92° C. Meanwhile, the first region A1 positioned at the lower portion of the LCD panel and adjacent to the cold electrode 12 has the lowest temperature of about 43.36° C. A difference between the temperatures of the first region A1 and the ninth region A9 is about 13.56° C.

To reduce both the increase of the temperature and a difference between the temperatures at the several positions of the LCD device, the heat generated from the lamp unit 10 should rapidly be dissipated toward an outside of the LCD device. In other words, the heat is forwarded to the reflection sheet, conducted to the container, and then dissipated toward the outside of the LCD device. However, since the conventional reflection sheet is made of synthetic resin having a low thermal conductivity, the heat forwarded from the lamp unit 10 cannot be rapidly dissipated to the outside of the LCD device.

### BRIEF SUMMARY OF THE INVENTION

The present invention provides a reflection sheet that has the improvement of display quality by rapidly dissipating a heat generated from a light source.

The present invention also provides a display device having the reflection sheet.

Exemplary embodiments of a reflection sheet in accordance with the present invention include a reflection layer that reflects light irradiated from an external device and a dissipating layer that is formed on the reflection layer and dissipates the heat generated from the light source toward an outside of a liquid crystal display (“LCD”) device.

Exemplary embodiments of a display device in accordance with the present invention include a display panel, a light source, and a reflection sheet. The display panel displays images using light. The light source is arranged under the display panel and emits the light toward the display panel. The reflection sheet is positioned under the light source. The reflection sheet reflects the light irradiated from the light source to the display panel and horizontally diffuses a heat generated from the light source to dissipate the heat toward an outside of the LCD device.

Exemplary embodiments of a method of dissipating heat in a display device in accordance with the present invention includes dissipating heat from the backlight assembly through the reflection sheet to a receiving container of the display device, such as by distributing the heat in a direction parallel to a planar surface of the reflection sheet faster than in a direction perpendicular to the planar surface of the reflection sheet. Thus, according to the present invention, the reflection sheet horizontally diffuses and then dissipates the heat so that a high concentration of the heat on a specific region in the display device may be prevented, thereby maintaining a constant luminance over the display device.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a plan view illustrating a temperature distribution in a conventional direct illumination type backlight assembly;

FIG. 2 is an exploded perspective view illustrating exemplary embodiments of a liquid crystal display (“LCD”) device in accordance with the present invention;

FIG. 3 is a partially exploded perspective view illustrating a combination of the lamps and the third container in FIG. 2;

FIG. 4 is a cross sectional view illustrating the reflection sheet in FIG. 2;

FIG. 5 is a perspective view schematically illustrating a molecular structure of graphite;

FIG. 6 is a cross sectional view taken along line 6-6 in FIG. 2;

FIG. 7 is an enlarged cross sectional view illustrating portion “A” in FIG. 6;

FIG. 8 is a plan view illustrating a temperature distribution in the lamps of FIG. 2; and

FIG. 9 is a plan view illustrating a temperature distribution in the LCD device of FIG. 2.

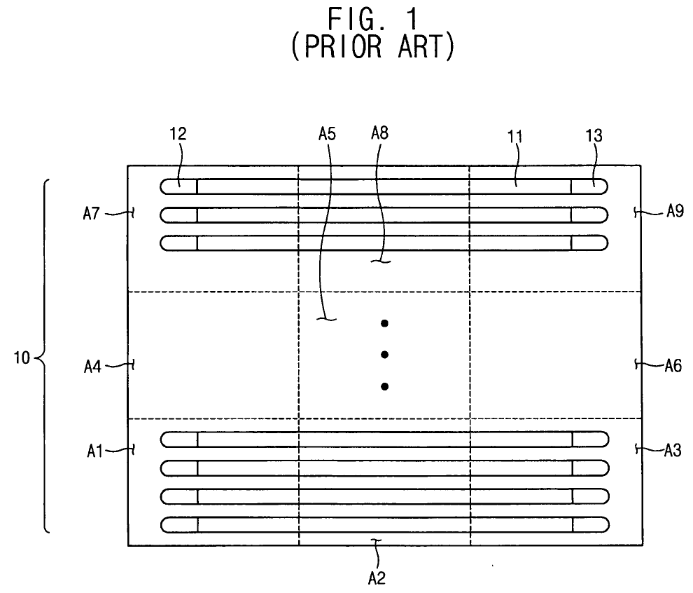

### DETAILED DESCRIPTION OF THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

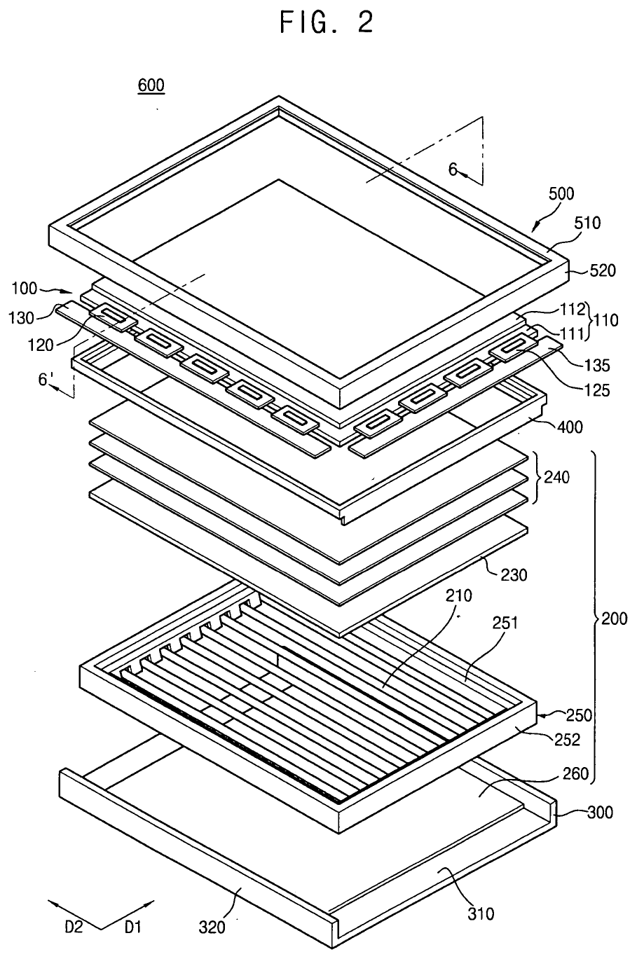

FIG. 2 is an exploded perspective view illustrating exemplary embodiments of an LCD device in accordance with the present invention.

Referring to FIG. 2, an LCD device 600 in accordance with the present embodiment includes a display panel assembly 100 that displays images responsive to image signals in accordance with light provided to the display panel assembly 100, a backlight assembly 200 that emits the light, a first container 300 that receives the backlight assembly 200, a second container 400 that receives the display panel assembly 100, and a top chassis 500.

The display panel assembly 100 includes an LCD panel 110, a plurality of first tape carrier packages (“TCPs”) 120 that are arranged in a second direction D2, a plurality of second TCPs 125 that are arranged in a first direction D1 substantially perpendicular to the second direction D2, a first printed circuit board (“PCB”) 130 that is positioned adjacent to the first TCPs 120, and a second PCB 135 that is positioned adjacent to the second TCPs 125.

The LCD panel 110 includes a thin film transistor (“TFT”) substrate 111, a color filter substrate 112 adhered to an upper face of the TFT substrate 111 and a liquid crystal (“LC”) layer (not shown) interposed between the TFT substrate 111 and the color filter substrate 112.

The TFT substrate 111 includes a plurality of pixels that are arranged in a matrix shape. Each of the pixels includes a gate line (not shown) extending in the first direction, a data line (not shown) intersecting the gate line in the second direction, and a pixel electrode. A TFT (not shown) serving as a switching element, which is electrically connected to the gate line and the data line, is provided to each of the pixels.

The color filter substrate 112 includes color filters (not shown) that display colors using the light, and a common electrode (not shown) that is formed on the color filters and is opposite to the pixel electrode.

The LC layer is interposed between the TFT substrate 111 and the color filter substrate 112. The LC layer is arranged in a specific direction in response to an electric field formed between the pixel electrode and the common electrode so that a transmissivity of the light provided to the backlight assembly 200 is controlled.

The first TCPs 120 are attached to a first edge of the LCD panel 110. The second TCPs 125 are attached to a second edge of the LCD panel 110 substantially perpendicular to the first edge of the LCD panel 110. The first and second TCPs 120 and 125 apply driving signals for driving the LCD panel 110 and timing signals for controlling an operation of the LCD panel 110 to the LCD panel 110.

The first and second TCPs 120 and 125 are electrically connected to the first and second PCBs 130 and 135, respectively. The first and second PCBs 130 and 135 generate the driving signals and the timing signals that are applied to the first and second TCPs 120 and 125.

The backlight assembly 200 providing the light to the LCD panel 110 is positioned under the display panel assembly 100.

The backlight assembly 200 includes a lamp unit 210 emitting the light, a diffusion plate 230 diffusing the light, optical sheets 240 uniformizing a luminance of the light, a third container 250 receiving the lamp unit 210, and a reflection sheet 260 reflecting the light.

The lamp unit 210 emits the light responsive to electric currents provided from an external device toward the LCD panel 110. The lamp unit 210 includes a plurality of lamps that are spaced apart from each other in an effective display region on which images of the LCD panel 110 are displayed.

In this embodiment, the backlight assembly 200 includes tubular lamps within the lamp unit 210 as a light source. Alternatively, the backlight assembly 200 may include other light sources, such as, but not limited to, a light emitting diode (“LED”).

The diffusion plate 230 and the optical sheets 240 are sequentially arrayed over the lamp unit 210. The diffusion plate 230 diffuses the light emitted from the lamp unit 210. The optical sheets 240 improve characteristics of the light (e.g. luminance and uniformity of the luminance) passing through the diffusion plate 230 and may include a prism sheet condensing the light.

The lamp unit 210, the diffusion plate 230, and the optical sheets 240 are received in the third container 250. The third container 250 includes a bottom plate 251 and a sidewall 252 vertically extending from an edge of the bottom plate 251. The diffusion plate 230 and the optical sheets 240 are sequentially stacked on a top face of the bottom plate 251. The lamp unit 210 is installed at a bottom face of the bottom plate 251.

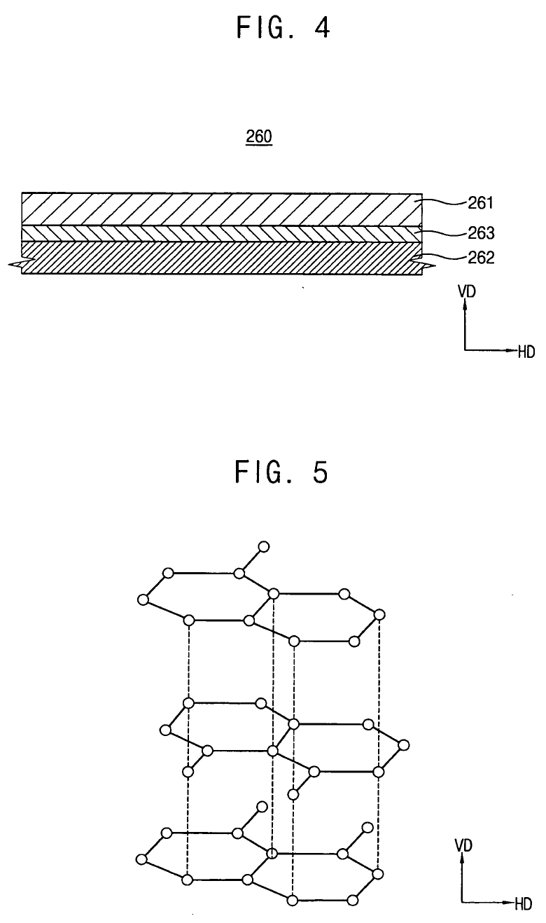

The reflection sheet 260 is positioned under the lamp unit 210. The reflection sheet 260 improves an efficiency of the light by reflecting the light toward the diffusion plate 230. Also, the reflection sheet 260 horizontally diffuses a heat generated from the lamp unit 210 and rapidly transmits the heat to the first container 300. The reflection sheet 260 will be explained in detail with reference to FIG. 4.

The backlight assembly 200 is received in the first container 300. The third container 250, in which the lamp unit 210 is received, is received in the first container 300. The reflection sheet 260 may also be received within the third container 250. The first container 300 includes a bottom face 310 on which the reflection sheet 260 is placed as illustrated, and a sidewall 320 vertically extending from an edge of the bottom face 310. To rapidly dissipate the heat, the first container 300 may include a lightweight, hardened metal, such as, but not limited to, aluminum, aluminum alloy, etc.

The second container 400 is interposed between the LCD panel 110 and the backlight assembly 200. The second container 400 has an opening through which the light emitted from the backlight assembly 200 passes. The LCD panel 110 is received in the second container 400. Also, the second container 400 is combined with the first container 300 so that the backlight assembly 200 may remain stationary relative to the second container 400.

The top chassis 500 guiding a position of the LCD panel 110 is arrayed over the LCD panel 110. The top chassis 500 includes a partially opened bottom face 510 and a sidewall 520 vertically extending from an edge of the bottom face 510. The top chassis 500 is combined with the third container 250 to fix the LCD panel 110 to the second container 400. The top chassis 500 covers an edge region of the LCD panel 110 except for the effective display region of the LCD device 600.

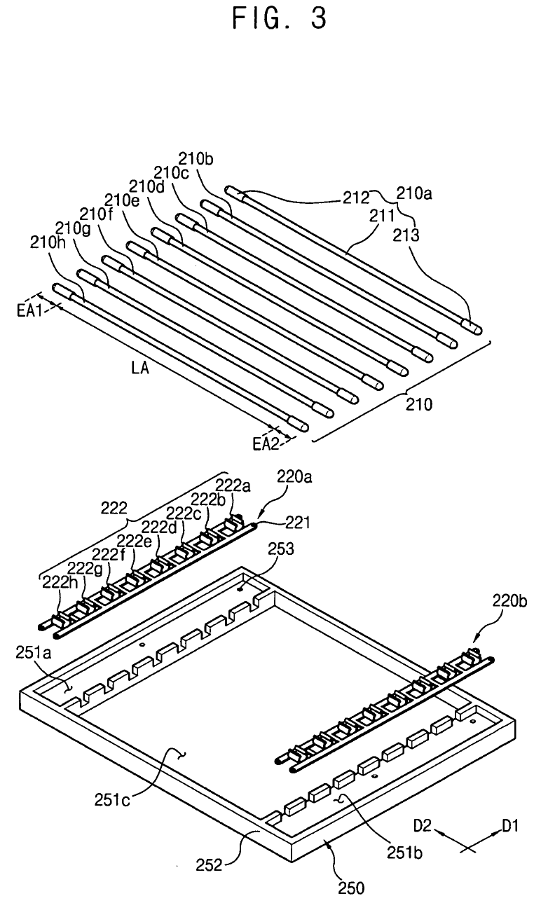

FIG. 3 is a partially exploded perspective view illustrating a combination of lamps and a third container in FIG. 2.

Referring to FIG. 3, the lamp unit 210 includes first, second, third, fourth, fifth, sixth, seventh, and eighth lamps 210a, 210b, 210c, 210d, 210e, 210f, 210g, and 210h. Alternatively, the number of the lamps may vary in accordance with a size of the LCD panel 110.

The first, second, third, fourth, fifth, sixth, seventh, and eighth lamps 210a, 210b, 210c, 210d, 210e, 210f, 210g, and 210h extend in the first direction D1 and are spaced apart from each other in the second direction D2. In this embodiment, each of the first to eighth lamps 210a to 210h has substantially the same structures. Thus, the first lamp 210a is illustrated in detail herein and any further illustrations of the second, third, fourth, fifth, sixth, seventh, and eighth lamps 210b, 210c, 210d, 210e, 210f, 210g, and 210h are omitted to avoid description duplication.

The first lamp 210a includes a lamp tube 211 that emits the light, a first electrode 212 installed at a first end EA1 of the lamp tube 211, and a second electrode 213 installed at a second end EA2 of the lamp tube 211 opposite to the first end EA1. The lamp tube 211 extends in the first direction D1. The first and second ends EA1 and EA2 are blocked. In other words, the first and second ends EA1 and EA2 are covered by the first and second electrodes 212, 213 and thus correspond to non-light emitting areas of the lamp unit 210.

Further, a discharge gas is injected into the lamp tube 211. A fluorescent layer is formed on inner faces of the lamp tube 211. Examples of the discharge gas include mercury (Hg), neon (Ne), argon (Ar), krypton (Kr), xenon (Xe), etc., for example. It will be understood that a combination of at least two discharge gases may be used as the discharge gas. When an electric current is applied to the lamp tube 211 from the first and second electrodes 212 and 213, the discharge gas is ionized to generate electrons. The mercury gas of these discharge gases is reacted with the electrons to emit an ultraviolet ray. The ultraviolet ray is reacted with the fluorescent layer to generate a visible light.

The first electrode 212 encloses the first end EA1 of the lamp tube 211 and is electrically connected to a power supply (not shown). The first electrode 212 provides the electric current from the power supply to the lamp tube 211.

The second electrode 213 encloses the second end EA2 of the lamp tube 211.

The second electrode 213 provides the power supply to the lamp tube 211. Here, a first voltage applied to the first electrode 212 is lower than that applied to the second electrode 213 so that a heat generated from the second electrode 213 is greater than that generated from the first electrode 212.

In this embodiment, the first and second electrodes 212 and 213 correspond to an external electrode. Alternatively, either or both of the first and second electrodes 212 and 213 may correspond to an internal electrode.

Since the first and second electrodes 212 and 213 cover the first and second ends EA1 and EA2 of the lamp tube 211, the light is not emitted from the first and second ends EA1 and EA2 of the lamp tube 211. Instead, the light is emitted from the effective display region LA between the first and second ends EA1 and EA2 of the lamp tube 211.

The first and second electrodes 212 and 213 of each of the first, second, third, fourth, fifth, sixth, seventh, and eighth lamps 210a, 210b, 210c, 210d, 210e, 210f, 210g, and 210h are inserted into first and second lamp holders 220a and 220b, respectively. The first and second lamp holders 220a and 220b transmit the electric current to the first and second electrodes 212 and 213 of each of the first to eighth lamps 210a to 210h. Also, the first and second lamp holders 220a and 220b secure the first to eighth lamps 210a to 210h.

The first lamp holder 220a is mounted at the first end EA1 of the first to eighth lamps 210a to 210h. To provide the electric current to each first electrode 212, the first electrodes 212 of the first to eighth lamps 210a to 210h are inserted into the first lamp holder 220a.

The second lamp holder 220b is mounted at the second end EA2 of the first to eighth lamps 210a to 210h. To provide the electric current to each second electrode 213, the second electrodes 213 of the first to eighth lamps 210a to 210h are inserted into the second lamp holder 220b.

In this embodiment, the first lamp holder 220a has substantially the same structure as the second lamp holder 220b. Thus, the structure of the first lamp holder 220a is illustrated in detail herein and any further illustrations with respect to that of the second lamp holder 220b are omitted to avoid description duplication.

The first lamp holder 220a includes a base substrate 221 combined with the third container 250, and a clip unit 222 protruded from an upper face of the base substrate 221.

The base substrate 221 extends in the first direction D1 and has at least one fixing hole for combining the base substrate 221 with the third container 250.

The clip unit 222 includes first, second, third, fourth, fifth, sixth, seventh, and eighth clips 222a, 222b, 222c, 222d, 222e, 222f, 222g, and 222h. The first to eighth clips 222a to 222h are arranged on the base substrate 221 and are spaced apart from each other in the first direction D1. The first to eighth clips 222a to 222h enclose the first electrodes 212 of the first to eighth lamps 210a to 210h and also secure the first to eighth lamps 210a to 210h, respectively.

To provide the electric current to the first to eighth lamps 210a to 210h, the first to eighth clips 222a to 222h are electrically connected to the first electrodes 212 of the first to eighth lamps 210a to 210h. However, it should be understood that the number of the clips may vary in accordance with that of the lamps.

The first and second lamp holders 220a and 220b are received in the bottom plate 251 of the third container 250. First and second receiving spaces 251a and 251b in which the first and second lamp holders 220a and 220b are received are formed at the lower face of the bottom plate 251. The first lamp holder 220a is received in the first receiving space 251a and the second lamp holder 220b is received in the second receiving space 251b.

At least one fixing groove 253 for combining the first and second lamp holders 220a and 220b with the third container 250 is formed at a surface portion of the bottom plate 251 in the first and second receiving spaces 251a and 251b. The fixing groove 253 corresponds to the fixing hole in the base substrate 221. A fastener, such as a screw (not shown) is threadedly inserted into the fixing groove 253 through the fixing hole in the base substrate 221 so that the first and second lamp holders 220a and 220b are combined with the third container 250. Other devices for securing the first and second lamp holders 220a, 220b to the third container 250 would also be within the scope of these embodiments.

FIG. 4 is a cross sectional view illustrating a reflection sheet in FIG. 2 and FIG. 5 is a schematically perspective view illustrating a molecular structure of graphite.

Referring to FIGS. 4 and 5, the reflection sheet 260 includes a reflection layer 261 and a dissipation member 262 formed beneath the reflection layer 261. The dissipation member 262 diffuses the heat generated from the lamp unit 210, as illustrated in FIG. 2.

The reflection layer 261 may be made from, such as, but not limited to, polyethylene terephthalate (“PET”). To improve a light efficiency, the reflection layer 261 reflects the light toward the diffusion plate 230 (FIG. 2).

To effectively dissipate the heat, the dissipation member 262 horizontally diffuses the heat, such as in a direction parallel to a planar surface of the reflection sheet 260. The dissipation member 262 may be made from, such as, but not limited to, an organic material including graphite.

As shown in FIG. 5, graphite corresponds to a mineral in a hexagonal system with carbon. A molecular structure of graphite is a lamellar structure of six cyclic carbons that are two-dimensionally connected. That is, molecules of graphite are connected to each other in a horizontal direction HD to form a plate-shaped structure. Graphite has a thermal conductivity in the horizontal direction HD higher than that in a vertical direction VD. As a result, the heat in the graphite is conducted in the horizontal direction HD faster than in the vertical direction VD.

Referring back to FIG. 4, the dissipation layer 262 containing graphite has a thermal conductivity of about 400 W/mk in the horizontal direction HD much higher than that of about 6 W/mk in the vertical direction VD.

Additionally, the reflection sheet 260 may further include a first adhesion member 263 interposed between the reflection layer 261 and the dissipation layer 262.

The reflection sheet 260 may alternatively include a diffusion material, operable to diffuse heat in a horizontal direction, and a reflecting material, operable to reflect light, where the reflecting material is mixed with the diffusion material. The diffusion material may include, for example, an organic material such as, but not limited to, graphite, and the reflecting material may include, by example only, PET.

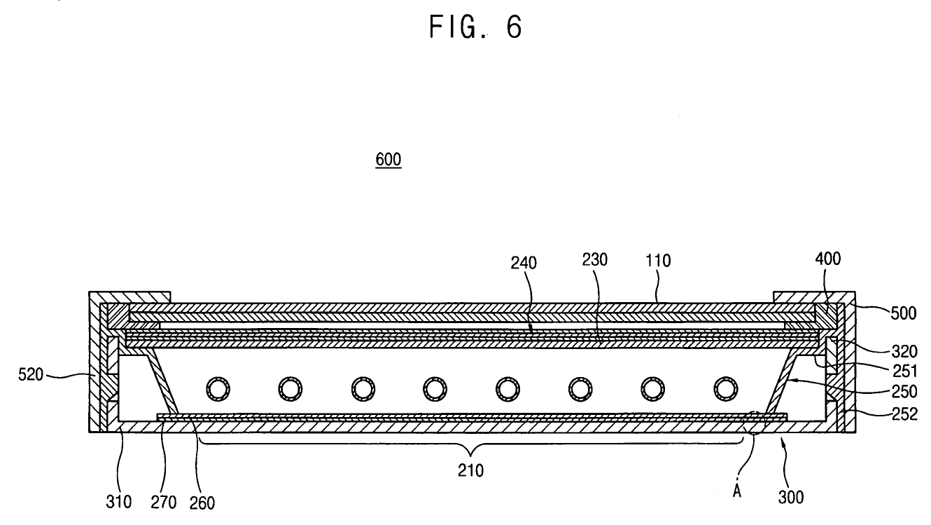

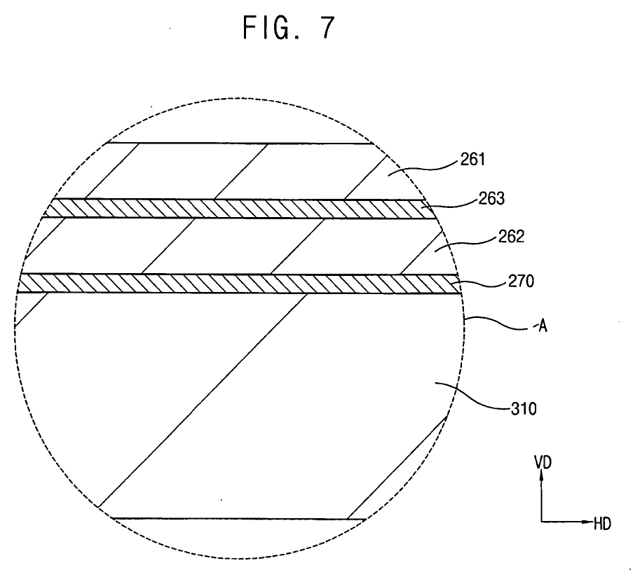

FIG. 6 is a cross sectional view taken along line 6-6 in FIG. 2 and FIG. 7 is an enlarged cross sectional view illustrating portion “A” in FIG. 6.

Referring to FIGS. 6 and 7, the third container 250 in which the reflection sheet 260 and the lamp unit 210 are sequentially stacked is attached to the bottom face 310 of the first container 300 via a second adhesion member 270.

The lamp unit 210 is positioned over the reflection layer 261. The first adhesion member 263 is attached to a lower face of the reflection layer 261. The dissipation member 262 is attached to a lower face of the first adhesion member 263.

The second adhesion member 270 is attached to a lower face of the dissipation member 262 and is interposed between the bottom face 310 of the first container 300 and the dissipation member 262.

The heat generated from the lamp unit 210 is conducted to the reflection layer 261 and then the dissipation member 262. The heat conducted to the dissipation member 262 is diffused in the horizontal direction HD. The heat that is diffused in the horizontal direction HD is conducted to the bottom face 310 of the first container 300, and the heat is then dissipated to outside of the LCD device 600.

As mentioned above, the dissipation member 262 has a thermal conductivity in the horizontal direction HD higher than that in the vertical direction VD. Thus, the heat in the dissipation member 262 diffuses in the horizontal direction HD so that the heat is uniformly distributed in the dissipation member 262. The heat diffusing in the horizontal direction HD is conducted in the vertical direction VD, and then transmitted to the bottom face 310 of the first container 300.

The first container 300 is combined with the third container 250. The sidewall 252 of the third container 250 encloses the sidewall 320 of the first container 300. The diffusion plate 230 and the optical sheets 240 are sequentially stacked on the bottom plate 251 of the third container 250. A stepped portion on which the second container 400 is placed is connected to both the bottom plate 251 and the sidewall 252 of the third container 250.

The LCD panel 110 is receivable in the second container 400. The top chassis 500 covers the edge portion of the LCD panel 110 and is combined with the third container 250. Here, the sidewall 520 of the top chassis 500 encloses the sidewall 252 of the third container 250.

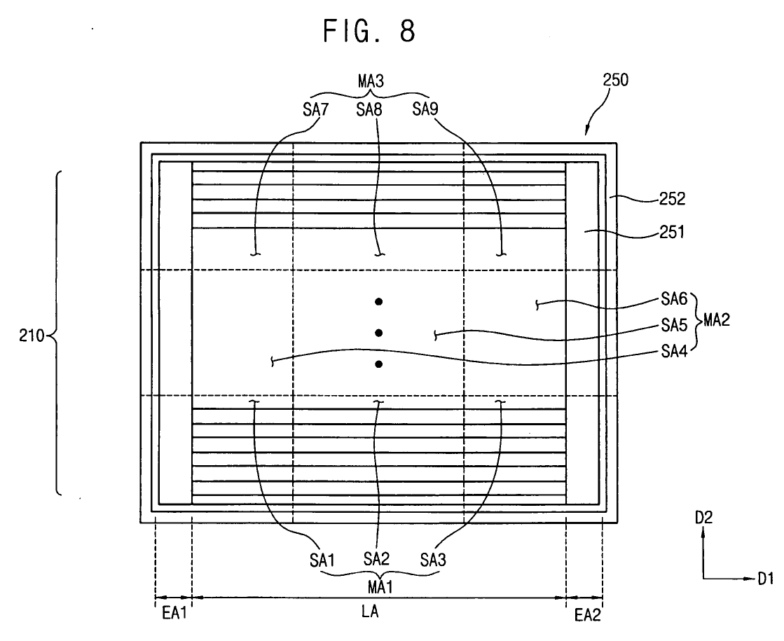

Employing the above embodiments, a method of dissipating heat in a display device is made possible, where the method includes dissipating heat from the backlight assembly through the reflection sheet to a receiving container of the display device, such as by distributing the heat in a direction parallel to a planar surface of the reflection sheet faster than in a direction perpendicular to the planar surface of the reflection sheet. The method may further include providing the reflection sheet with a reflection material reflecting a light from the backlight assembly and a dissipation material dissipating the heat from the backlight assembly. In some embodiments, the reflection material is provided in a reflection layer and the dissipation material is provided in a dissipation layer, and the method includes adhering the reflection layer to the dissipation layer with a first adhesion member, and adhering the dissipation layer to the receiving container of the display device with a second adhesion member. In other embodiments, the method includes mixing the reflection material with the dissipation material to form the reflection sheet. FIG. 8 is a plan view illustrating temperature distribution in the lamp unit 210 in FIG. 2.

Referring to FIG. 8, the lamp unit 210 is received in the third container 250.

A region in which the lamp unit 210 is received is divided into first, second, and third main regions MA1, MA2, and MA3 having substantially the same sizes. The first, second, and third main regions MA1, MA2, and MA3 are upwardly arranged in the second direction D2 as shown.

The first main region MA1 is divided into first, second, and third sub-regions SA1, SA2, and SA3 sequentially arranged in the first direction D1. The second main region MA2 is positioned adjacent to the first main region MA1. The second main region MA2 is divided into fourth, fifth, and sixth sub-regions SA4, SA5, and SA6 sequentially arranged in the first direction D1. The third main region MA3 is positioned adjacent to the second main region MA2. The third main region MA3 is divided into seventh, eighth, and ninth sub-regions SA7, SA8, and SA9 sequentially arranged in the first direction D1. The first, second, third, fourth, fifth, sixth, seventh, eighth, and ninth sub-regions SA1, SA2, SA3, SA4, SA5, SA6, SA7, SA8, and SA9 have substantially the same sizes. The first end EA1 of the lamp unit 210 is placed in the first, fourth, and seventh sub-regions SA1, SA4, and SA7. The second end EA2 of the lamp unit 210 is placed in the third, sixth, and ninth sub-regions SA3, SA6, and SA9. Temperatures of each of the sub-regions in the backlight assembly of the present invention with the reflection sheet 260 and in the conventional backlight assembly with a conventional reflection sheet were measured. Here, the backlight assembly of the present invention and the conventional backlight assembly were operated under substantially the same conditions. The measured temperatures are shown in Table 2 as follows.

TABLE 2

| | | Temperature (° C.) | |
|---|---|---|---|
| | | Conventional | Backlight assembly |
| Region | | back light | of the present |
| Main region | Sub-region | assembly | invention |
| First | First sub-region | 85.7 | 80.2 |
| main region | Second sub-region | 90.9 | 85.3 |
| | Third sub-region | 109.1 | 104.9 |
| Second | Fourth sub-region | 87.6 | 82.0 |
| main region | Fifth sub-region | 94.2 | 86.8 |
| | Sixth sub-region | 105.2 | 101.3 |
| Third | Seventh sub-region | 85.5 | 81.6 |
| main region | Eighth sub-region | 90.0 | 92.7 |
| | Ninth sub-region | 112.6 | 98.0 |

As shown in Table 2, the third main region MA3 had a temperature higher than those of the first and second main regions MA1 and MA2. Thus, it shall be noted that the heat in the first, second, and third main regions MA1, MA2, and MA3 was concentrated on upper portions of the backlight assembly of the present invention and the conventional backlight assembly. I In the first main region MA1, the first sub-region SA1 had the lowest temperature and the third sub-region SA3 had the highest temperature. In the second main region MA2, the fourth sub-region SA4 had the lowest temperature and the sixth sub-region SA6 had the highest temperature. And in the third main region MA3, the seventh sub-region SA7 had the lowest temperature and the ninth sub-region SA9 had the highest temperature.

That is, since each of the first electrodes of the lamp unit 210 to which a first voltage was applied was positioned in the first, fourth, and seventh sub-regions SA1, SA4, and SA7 and each of the second electrodes of the lamp unit 210 to which a second voltage higher than the first voltage was applied was positioned in the third, sixth, and ninth sub-regions SA3, SA6, and SA9, the first, fourth, and seventh sub-regions SA1, SA4, and SA7 had temperatures lower than those of the third, sixth, and ninth sub-regions SA3, SA6, and SA9, respectively.

Meanwhile, each of the first through ninth sub-regions SA1 through SA9 in the backlight assembly of the present invention had temperatures substantially about 10° C. lower than those of each of the first through ninth sub-regions SA1 through SA9 in the conventional backlight assembly. In particular, the third, sixth, and ninth sub-regions SA3, SA6, and SA9 in the backlight assembly of the present invention had temperatures substantially about 5° C. to about 14° C. lower than those in the conventional backlight assembly. Also, in the backlight assembly of the present invention, a difference between temperatures of the first and ninth sub-regions SA1 and SA9 was about 18° C. On the contrary, in the conventional backlight assembly, a difference between temperatures of the first and ninth sub-regions SA1 and SA9 was about 27° C.

This results from the thermal conductivity of the dissipation member 262 in the horizontal direction higher than that of the dissipation member 262 in the vertical direction. That is, the dissipation member 262 diffuses the heat in the third, sixth, and ninth sub-regions SA3, SA6, and SA9 toward other sub-regions SA1, SA2, SA4, SA5, SA7, and SA8. As a result, the differences between the temperatures of the first through ninth sub-regions SA1 through SA9 are reduced.

As described above, the reflection sheet 260 prevents the concentration of the heat on the third, sixth, and ninth sub-regions SA3, SA6, and SA9, and thus a luminance deviation between the first and second ends of the lamp unit 210 may be reduced. Also, the reflection sheet 260 conducts the heat in the horizontal direction and then conducts the horizontally conducted heat in the vertical direction. As a result, the reflection sheet 260 rapidly transmits the heat to the first container 300, and thus a temperature increase in the backlight assembly 200 may be suppressed. Thus, the LCD device 600 may have uniform luminance.

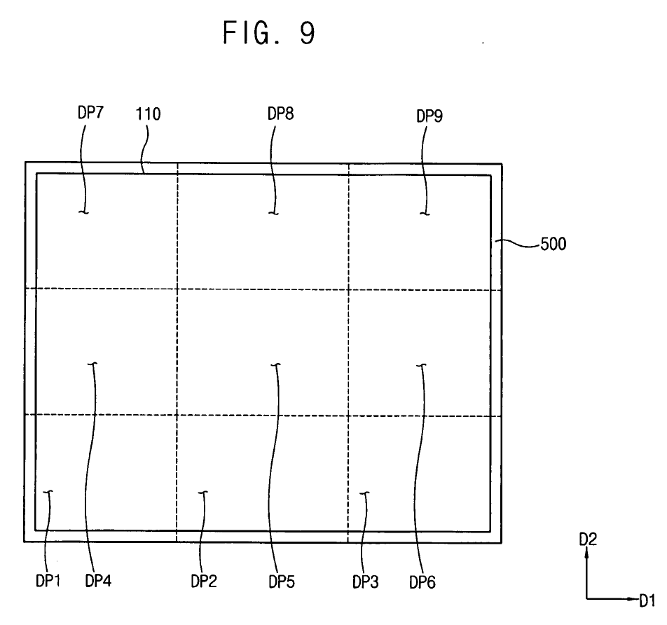

FIG. 9 is a plan view illustrating temperature distribution in the LCD device 600 in FIG. 2.

Referring to FIG. 9, the effective display region of the LCD panel 110 is divided into first, second, third, fourth, fifth, sixth, seventh, eighth, and ninth display regions DP1, DP2, DP3, DP4, DP5, DP6, DP7, DP8, and DP9 having substantially the same sizes and corresponding to the first, second, third, fourth, fifth, sixth, seventh, eighth, and ninth sub-regions SA1, SA2, SA3, SA4, SA5, SA6, SA7, SA8, and SA9, respectively, of the backlight assembly 200.

The first, second, and third display regions DP1, DP2, and DP3 corresponding to the first, second, and third sub-regions SA1, SA2, and SA3, respectively, is defined adjacent to the bottom portion of the LCD panel 110 as shown. The fourth, fifth, and sixth display regions DP4, DP5, and DP6 corresponding to the fourth, fifth, and sixth sub-regions SA4, SA5, and SA6, respectively, is defined adjacent to the first, second, and third display regions DP1, DP2, and DP3. And the seventh, eighth, and ninth display regions DP7, DP8, and DP9 corresponding to the seventh, eighth, and ninth sub-regions SA7, SA8, and SA9, respectively, were defined adjacent to the fourth, fifth, and sixth display regions DP4, DP5, and DP6.

Meanwhile, the first, fourth, and seventh display regions DP1, DP4, and DP7 is defined adjacent to the first end EA1 of the lamp unit 210. The third, sixth, and ninth display regions DP3, DP6, and DP9 are defined adjacent to the second end EA2 of the lamp unit 210.

Here, a surface temperature of the LCD panel 110 may be proportional to a temperature of the lamp unit 210. Thus, a temperature distribution of the first, second, third, fourth, fifth, sixth, seventh, eighth, and ninth display regions DP1, DP2, DP3, DP4, DP5, DP6, DP7, DP8, and DP9 may be substantially similar to that of the first, second, third, fourth, fifth, sixth, seventh, eighth, and ninth sub-regions SA1, SA2, SA3, SA4, SA5, SA6, SA7, SA8, and SA9. For example, when the temperature of the first sub-region SA1 becomes higher, the first display region DP1 may be more increased, and vice versa.

Alternately, if the LCD panel 110 is spaced apart from the lamp unit 210, then the first, second, third, fourth, fifth, sixth, seventh, eighth, and ninth sub-regions SA1, SA2, SA3, SA4, SA5, SA6, SA7, SA8, and SA9 may have temperatures lower than those of the first, second, third, fourth, fifth, sixth, seventh, eighth, and ninth display regions DP1, DP2, DP3, DP4, DP5, DP6, DP7, DP8, and DP9.

Also, the first through ninth sub-regions SA1 through SA9 may have variations of the temperatures less than those of the first through ninth display regions DP1 through DP9. For example, when the temperature of the first sub-region SA1 decreases by about 10° C., the temperature of the first display region DP1 may decrease by about 2° C.

Temperatures of each of the first through ninth sub-regions SA1 through SA9 in the LCD panel 110 of the present invention with the reflection sheet 260 and the conventional LCD panel with a conventional reflection sheet were measured. Here, the LCD panel 110 of the present invention and the conventional LCD panel were operated under substantially the same conditions. The measured temperatures are shown in Table 3 as follows.

TABLE 3

Temperature (° C.)

| Region | Conventional | LCD panel of the present |
|---|---|---|
| Display region | LCD panel | invention |
| Fifth display region | 42.5 | 40.0 |
| Sixth display region | 45.7 | 43.2 |
| Eighth display region | 42.8 | 41.4 |
| Ninth display region | 46.3 | 44.1 |

As shown in Table 3, in the conventional LCD panel, the display regions had temperatures of about 42° C. to about 46° C. On the contrary, in the LCD panel 110 of the present invention, the display regions had temperatures of about 40° C. to about 44° C.

It shall be noted that the LCD panel 110 of the present invention with the reflection sheet 260 has a surface temperature substantially about 2° C. lower than that of the conventional LCD panel, A difference between temperatures of the LCD panel 110 of the present invention and the conventional LCD panel may be identified with human eyes.

In particular, to reduce the temperature of the LCD panel 110 by about 2° C., reducing an electric current, which is provided to the lamp unit 210, by about 1 mA to about 2 mA is in demand. Meanwhile, when the electric current is reduced, the luminance of the lamp unit is also decreased, thereby deteriorating a display quality of the LCD panel 110. However, the reflection sheet 260 reduces the surface temperature of the LCD panel 110 without having to reduce the electric current, which would otherwise reduce a display quality of the LCD panel 110. According to the present invention, the reflection sheet 260 having the thermal conductivity in the horizontal direction higher than that in the vertical direction is employed in the LCD device 600. Thus, the reflection sheet 260 rapidly diffuses the heat generated from the lamp unit 210 in the horizontal direction, and thus a difference between the temperatures of the first and second electrodes of the lamp unit 210 may be reduced. As a result, the LCD device 600 may have uniform luminance.

Also, since the reflection sheet 260 rapidly conducts the heat in the horizontal direction and then conducts the horizontally conducted heat in the vertical direction, the heat may rapidly be transmitted to the first container 300. Accordingly, the increase of the temperature in the backlight assembly may be suppressed, thereby increasing the luminance of the lamp unit 210 and improving a display quality of the LCD device 600.

Having described the exemplary embodiments of the present invention and its advantages, it is noted that various changes, substitutions, and alterations can be made herein without departing from the spirit and scope of the invention as defined by appended claims.

What is claimed is:

1. A reflection sheet comprising:
a reflection layer reflecting light; and
a dissipation layer positioned on the reflection layer.

2. The reflection sheet of claim 1, wherein the dissipation layer comprises an organic material containing graphite.

3. The reflection sheet of claim 1, wherein the dissipation layer has a thermal conductivity in a horizontal direction higher than that in a vertical direction.

4. The reflection sheet of claim 1, wherein the dissipation layer conducts heat faster in a direction parallel to a planar surface of the reflection sheet than in a direction perpendicular to a planar surface of the reflection sheet.

5. The reflection sheet of claim 1, further comprising an adhesion member interposed between the reflection layer and the dissipation layer.

6. The reflection sheet of claim 1, wherein the reflection layer comprises polyethylene terephthalate.

7. The reflection sheet of claim 1, wherein the dissipation layer includes molecules having two-dimensionally connected cyclic carbons.

8. A display device comprising:
a display panel operable to display images using light;
a light source positioned under the display panel and operable to emit the light toward the display panel; and
a reflection sheet positioned under the light source, and operable to reflect the light toward the display panel and dissipate heat generated from the light source toward an outside of the light source.

9. The display device of claim 8, wherein the reflection sheet comprises:
a reflection layer operable to reflect light; and
a dissipation layer positioned on the reflection layer and operable to dissipate the heat generated from the light source toward the outside of the light source.

10. The display device of claim 9, wherein the dissipation layer comprises an organic material containing graphite.

11. The display device of claim 9, wherein the dissipation layer has a thermal conductivity in a horizontal direction higher than that in a vertical direction.

12. The display device of claim 9, wherein the reflection sheet further comprises an adhesion member interposed between the reflection layer and the dissipation layer.

13. The display device of claim 9, further comprising a container in which the reflection sheet is received, the container operable to dissipate the heat conducted from the reflection sheet toward the outside of the light source.

14. The display device of claim 13, wherein the dissipation layer is positioned between a bottom face of the container and the reflection layer.

15. The display device of claim 13, further comprising an adhesion member interposed between the reflection sheet and the container.

16. The display device of claim 15, further comprising an additional adhesion member interposed between the reflection layer and the dissipation layer.

17. The display device of claim 8, wherein the reflection sheet comprises:
an organic material operable to diffuse heat in a direction parallel with a planar surface of the reflection sheet; and
a reflecting material mixed with the organic material and operable to reflect light.

18. A reflection sheet comprising:
an organic material operable to diffuse heat in a horizontal direction; and
a reflecting material mixed with the organic material and operable to reflect light.

19. The reflection sheet of claim 18, wherein the organic material comprises graphite and the reflecting material comprises polyethylene terephthalate.

20. A method of dissipating heat in a display device, the display device including a reflection sheet and a backlight assembly positioned adjacent the reflection sheet, the method comprising:
dissipating heat from the backlight assembly through the reflection sheet to a receiving container of the display device.

21. The method of claim 20, wherein dissipating heat from the backlight assembly through the reflection sheet includes distributing the heat in a direction parallel to a planar surface of the reflection sheet faster than in a direction perpendicular to the planar surface of the reflection sheet.

22. The method of claim 20, further comprising providing the reflection sheet with a reflection material reflecting a light from the backlight assembly and a dissipation material dissipating the heat from the backlight assembly.

23. The method of 22, wherein the reflection material is provided in a reflection layer and the dissipation material is provided in a dissipation layer, the method further comprising adhering the reflection layer to the dissipation layer with a first adhesion member.

24. The method of claim 23, further comprising adhering the dissipation layer to the receiving container of the display device with a second adhesion member.

25. The method of claim 22, further comprising mixing the reflection material with the dissipation material to form the reflection sheet.
